(19) United States
(12) Patent Application Publication
(10) Pub. No.: US 2025/0340376 A1
(43) Pub. Date: Nov. 6, 2025

(54) SIMPLIFIED WIRELESS WAREHOUSE ORGANIZATION SYSTEM

(71) Applicant: NIMMSTA GMBH, Aßling (DE)

(72) Inventors: Andreas FUNKENHAUSER, Aßling (DE); Florian RUHLAND, Erding (DE); Stefan RICHTER, Pfaffing (DE)

(21) Appl. No.: 18/867,589

(22) PCT Filed: May 24, 2023
(86) PCT No.: PCT/EP2023/063979

§ 371 Date: Nov. 20, 2024

(30) Foreign Application Priority Data
May 24, 2022 (DE) 20 2022 102 879.6

(51) Int. Cl. B65G 1/04

(52) U.S. Cl. CPC B65G 1/0492; B65G 2203/0216

(57) ABSTRACT

A warehouse organisation system comprising a storage area having multiple defined storage locations for storing and retrieving storage items, at least one mobile device that can be supplied with information relating to which storage location should be called upon next, and multiple mobile, wireless transmitters with an individual identifier, wherein the signal thereof can be received by the mobile device and assigned, wherein a signal of each transmitter can be received by the mobile device only within a sub-region of the warehouse, wherein at least one transmitter is assigned to a defined storage location and/or a storage item. Each transmitter is assigned a receiver and a signalling unit, and as soon as the mobile device receives the signal of the storage item and/or storage location forming the target, it activates the associated signalling unit such that the storage or retrieval location to be controlled can be locally perceived.

The invention relates to a warehouse organization system.

### TECHNICAL BACKGROUND

Warehouse organization systems are well-known in extensive forms.

The classical warehouse organization systems typically use in most cases a LAN-based network system.

In these systems, each smallest addressable storage location is connected to the server via a cable, through which it communicates, and the warehouse management is usually handled with the help of a traditional inventory management system.

Such a warehouse organization system has many strengths, particularly allowing the implementation of a high number of functions.

The disadvantage of such a system is that it initially requires quite an effort intensive setup and usually also needs at least a centralized management, which is handled by a correspondingly trained employee via a PC.

However, such warehouse organization systems can still be highly efficient when operated automatically with the help of storage and retrieval machines or other bots that, for instance, can be quickly directed to a storage location using a local warehouse navigation system, where an item needs to be deposited or retrieved.

Even so, the efficiency of these warehouse organization systems needs improvement, especially in cases where full automation using storage and retrieval machines or other bots is not possible or economically viable but where the required walking or handling distances for depositing or retrieving an item at a specific storage location must still be covered by humans.

For this purpose, systems have already been proposed that locate individual employees on their walking routes and guide them as quickly as possible to the storage location where an item needs to be deposited or picked up. However, such systems have only gained limited acceptance. This is because current guidance systems track the employee, referred to as the “picker,” throughout their entire walking route. The data collected in such a manner are processed by the server to generate the guidance signals. As a result, the picker often feels as though they are under Orwellian surveillance, even if no data analysis is actually performed on the server that could draw conclusions about the picker's individual performance.

Furthermore, the known warehouse organization systems are still too cumbersome to set up, at least in cases where a particularly low-cost or spontaneously established warehouse is needed, but should still be as efficient as possible to operate. There is a high demand for such solutions. In the simplest case, a spontaneously established warehouse is needed because the existing warehouse is overwhelmed by a sudden surge in orders. In other cases, such spontaneously established warehouses are required to manage crisis situations, such as during disasters or, sadly, as we see again these days, during times of war.

### OBJECTIVE OF THE INVENTION

In light of this background, the objective of the invention is to provide means by which a warehouse can be set up in the simplest possible manner, allowing individual storage locations to be accessed as efficiently as possible by a picker.

### SOLUTION ACCORDING TO THE INVENTION

The solution to this problem is provided by a warehouse organization system that comprises a storage area with multiple defined storage locations for depositing and retrieving stored items.

The warehouse organization system further includes at least one fully autonomous mobile device, which typically operates independently thanks to its own power source and wireless functionality. This mobile device can be moved from at least one starting point to all storage locations within the storage area. The mobile device can be provided with information about which storage location should be accessed next.

The system also includes multiple transmitters, each with a unique identifier. The signal from these transmitters can be received and identified by the mobile device based on their unique identifiers. The transmission power of each transmitter is designed so that the signal can only be received by the mobile device within a specific subsection of the warehouse. Each defined storage location and/or the item stored there is assigned at least one transmitter.

Each transmitter is associated with at least one receiver and a signaling device.

The mobile device is designed so that, once it receives the signal from the transmitter at the target storage location or for the item in question, it activates the signaling device associated with that storage location or item via the receiver. For example, it might send a light signal.

In this way, the picker, who has advanced to a point where the target storage location or item is within visual range, is made aware of exactly where the target storage location or item is located. This saves significant time, especially in the final part of the picker's route. At the same time, the reliability of his work is greatly increased. Thanks to the signaling, it is almost impossible for the picker, after long hours of work, to mistakenly pick up an item from the wrong storage location or retrieve the wrong item from a designated location, especially in situations with multiple items stored in the same location.

In most cases, each transmitter does not send signals continuously but at intervals, in specific time periods. Typically, it transmits only for a brief duration, such as 10 seconds. By this power is saved.

In certain cases, each transmitter is equipped with a timer that turns the transmitter off during specific periods, for example, during nighttime warehouse closures. Alternatively, the timer may be set so that the transmitter during specific periods of time sends signals only with longer interruption intervals in-between compared to normal operation, for instance, during nighttime closures. This also conserves power.

With the help of the warehouse organization system according to the invention, a warehouse can be set up quickly and efficiently.

The picker in charge usually carries the mobile device on their body, preferably as a back of the hand-mounted device attached to the back of a glove or cuff. The mobile device typically includes a scanner and, ideally, a small screen, sometimes a thumb-operated trigger is particularly useful for interacting with the back of the hand-mounted device, for example, to initiate a scan.

Then the process typically works as follows: the picker in charge scans the information on the goods using the mobile device, often in the form of a barcode or, preferably, a QR code attached to the goods. The picker then most often in the same manner scans the information on a tag associated with the system according to the invention. This allows the mobile device to establish a data link between the goods and the tag.

The picker then proceeds to the designated storage location and deposits both the goods and the tag there.

The data collected by the handheld device is usually saved centrally at regular intervals.

When the stored goods need to be retrieved, the handheld device either still has the information about which tag was used to store the goods or it receives this information from the central server.

The handheld device then ideally generates a map of the warehouse, highlighting the location to be accessed and possibly visualizing an optimal walking route. The picker, who is familiar with the layout of the warehouse, uses this for orientation. He begins heading toward the designated storage location. The handheld device is in standby mode, waiting to receive the signal from the transmitter associated with the target storage location.

As soon as the picker comes within visual range of the target storage location, the transmitter's signal is strong enough to be received by the handheld device. Once the handheld device receives the transmitter's signal, it sends a signal to the receiver linked to the transmitter. Thereby the handheld device activates the signaling device associated with the transmitter at the storage location. If the signaling device is a light or LED, it begins to illuminate. The picker immediately identifies the target storage location or item on the final stretch of their route. This eliminates the time-consuming search for the correct location just before reaching it and removes the as well time consuming need for the picker to double-check if they are at the correct storage location.

As an optional feature, the mobile device could even be a smartphone, as soon as it is equipped with the appropriate app, although a wrist-mounted scanner is clearly preferred.

Preferably multiple individuals can work in parallel with several mobile devices. Ideally, the data flow in the system is organized in such a way that the data collected by the multiple mobile devices throughout the day is synchronized later, typically after the shift ends. This enables the rapid setup of an ad hoc, spontaneous warehouse. The system allows for many people to work simultaneously, each performing relatively simple tasks, which means they can be quickly trained.

A major advantage of this warehouse organization system is that the navigation to the target storage location can be achieved purely through local communication between the mobile device and the respective transmitter, without any connection to a central server that could track the picker's movements. This greatly increases the inventive storage system's acceptance. Additionally, the storage organization system according to the invention only requires very simple data processing, as preferably the activation of the signaling device depends solely on the mobile device receiving a signal from the transmitter at the designated storage location, which is purely distance-based.

### PREFERRED EMBODIMENTS

The storage organization system according to the invention can be further improved in various ways.

Ideally, the transmitters associated with the storage organization system send Bluetooth signals that can be received by the mobile device. Bluetooth technology has proven to be very reliable and technically mature for years.

It is particularly advantageous if the Bluetooth signals sent by the transmitters have an average reception range preferably under 15 meters, better under 10 meters. This is because if the transmitters come into contact with the handheld device too early and then activate the signaling device prematurely, it consumes too much battery power.

Ideally, the transmission power of the transmitters in the inventive storage organization system can be adjusted to even lower levels, ideally to a range of under 3 meters. In this way, the inventive storage organization system can be set accordingly before customer delivery, for example, in cases where the storage organization system is operated in a small space instead of a warehouse, such as in a pharmacy with its well-known drawer outputs or in a hardware store, where hundreds of different screws are offered individually in small drawers.

Ideally, the mobile device can identify whether it can receive a signal from at least one transmitter that is on the correct path to the currently targeted storage location, from which no signal has yet been received. In this case, the mobile device can temporarily activate the signaling device associated with this transmitter to confirm the direction of movement. Of course, the signaling device is activated in such a manner that its signal differs from the signal of another signaling device that indicates reaching the correct storage location. For example, if LEDs are used as signaling devices, the picker can be guided along the path to the correct storage location by lighting up LEDs in a specific color, such as white, until they get close enough for an LED in another color, such as green, to light up.

The same option can be realized in the opposite direction, either instead or additionally. For this purpose, the mobile device is set up to receive a signal from at least one transmitter that is not on the correct path to the currently targeted storage location. The mobile device then temporarily activates the associated signaling device to warn against a wrong direction of movement, especially when multiple signals have already been received from transmitters that are not on the correct path but have not yet led to a signal.

Ideally, each transmitter, receiver, and signaling device are combined into a tag, preferably in a unified housing. It is particularly advantageous if the housing is moisture-resistant and/or shock-resistant so that it can withstand impacts from a height of at least 2.20 meters on a concrete floor multiple times without damage.

Typically, a power source for the transmitter, receiver, and signaling device is housed in the tag. Rechargeable batteries can be considered for this purpose. However, non-rechargeable batteries are preferably used as the power source because they have a lower self-discharge rate in long-term use and therefore operate more reliably, especially in warehouses with long storage or turnover times.

Ideally, the tag has a battery status monitor that activates the signaling device when the battery is about to reach its depleted state or has already done so. For example, the LED of the tag may blink without interruption and/or in a specific color and/or with a specific frequency and/or a specific pattern. This signals during a walk through the warehouse for inspection purposes or when stocking a different storage location that a new battery needs to be provided for a specific storage location.

As already roughly mentioned, it is ideal if the signaling device is at least one LED, preferably a multi-color LED or if it consists of several LEDs emitting different spectral colors. In this way, not only different information can be transmitted via a simple LED. Furthermore, it ensures that multiple pickers do not disturb each other while working in the warehouse. For instance, if one picker is assigned the color green, they can ignore LEDs that light up in other colors, such as yellow, pink, blue, and violet, and know that a red-emitting LED indicates a disturbance that concerns all pickers.

Ideally, the signaling device does not activate the LED in continuous operation but blinks to signal a storage location or indicate another state. The blinking mode saves significantly on power compared to continuous operation, which is significant since the battery energy available to each tag is limited.

Ideally, the signaling device can activate the at least one LED with different blinking patterns. This includes different, consistent blinking frequencies, but also blinking patterns like “short short short long” and similar. This way, it is possible to signal various information efficiently using a simple LED.

The tag is preferably equipped with means that allow it to be attached to its assigned storage location without tools and at least essentially without loss—such as by means of a magnet, a Velcro fastener, a ball locking bolt, or a mounting base or pocket attached there.

It is particularly advantageous if the tags are designed so that one tag can exchange data stored in at least one of the tags by approaching or coming into contact with another tag, preferably directly from tag to tag. This significantly facilitates the exchange of tags that indicate through their signaling device that their battery voltage will soon be insufficient. Any employee carrying a fresh tag, regardless of whether they currently have a mobile device available, can rectify this by transferring data from the old tag to the new tag and then returning the old tag to the service point for maintenance.

It is particularly advantageous if each tag carries an individual barcode or an individual QR code, and the mobile device includes a scanner that can read this. In this way, two quick scanning actions are sufficient to match the warehouse goods with the corresponding tag.

In some cases, it is desirable for the mobile device to be able to store the duration of its stay in front of a specific tag, ideally without saving any other movement data of the mobile device user or picker. In this way, useful information can be gathered from practice to improve warehouse flow. For example, if it is observed that a picker lingers for long periods in front of tags with frequently needed warehouse products while spending less time in front of tags with less frequently needed products, this could indicate that the frequently needed products should be stored in a more accessible location, such as at waist height rather than overhead, while the less frequently needed products should be stored there instead.

It is particularly advantageous if the mobile device also has an LED and a control that allows the LED to light up in the same manner as the LED that will light up at the targeted storage location when the picker comes within range. This ensures that the picker always knows which color of LED or which LED blinking pattern to look for, even when the warehouse is busy and LEDs of specific colors or blinking patterns are visible in many places.

Conveniently, the mobile device features a display that shows a map of the storage area at least when starting a new search run. This map indicates the next storage location to be visited. Preferably, the walking route is also displayed. This way, the user gets an initial orientation, can begin their way, and cover a good portion of the distance without needing to be signaled. This saves power and, especially when multiple people are working in parallel in the warehouse, improves the work atmosphere because signaling is not happening everywhere from afar before pickers have even approached the respective storage location.

In this context, it is beneficial if the mobile device allows the aforementioned LED to light up only after displaying the mentioned map, ideally up to 1.5 seconds later. This way, the picker is not distracted from their view of the map but still reliably receives the information about which type of LED or LED blinking pattern they need to look out for.

It is particularly advantageous for the mobile device to trigger a provisioning process on-site when approaching the tag of the targeted storage location and/or the targeted product. It is intended that the mobile device preferably activates a drive assigned to the storage location when it first receives a signal from the tag of the targeted storage location and/or the targeted product, for example, bringing the storage compartment from the ceiling position to picking height or sliding out a drawer far enough so that the item to be picked can be easily retrieved.

It has proven beneficial for each tag to have a housing made up of two halves.

Ideally, one half of the housing is transparent and allows the radiation from the LED, usually mounted on a circuit board inside, to pass through.

Preferably, the half of the housing used is so opaque that the upper half appears to glow entirely or predominantly due to the radiation from the LED inside.

In many cases, it is advantageous if the upper half forms at least one light guide that directly connects to the LED, collects the radiation emitted by the LED, and channels it to the upper half.

### VARIOUS

So far, the discussion has primarily focused on storage locations. However, the system according to the invention can also be used for general location finding, such as possibly implemented on a visitor's smartphone via an app as a space allocator in a large concert hall.

Protection is also sought for a corresponding use and for a method for storage organization, as disclosed here.

1. A storage organization system comprising:
a storage area that includes a plurality of defined storage locations for depositing and retrieving storage items;
at least one mobile device that can be moved rom at least one storage starting point to the defined storage locations and can be fed information on which of the defined storage locations should subsequently be visited; and
a plurality of fully mobile wireless transmitters each with an individual identification, wherein a signal of each of the plurality of mobile wireless transmitters can be received and assigned by the at least one mobile device,
wherein a transmission power of each of the plurality of mobile wireless transmitters is designed such that the signal of each of the plurality of mobile wireless transmitters can only be received by the mobile device within a partial area of the storage area,
wherein respectively at least one transmitter from the plurality of fully mobile wireless transmitters is assigned to one of the defined storage locations and/or a storage item,
wherein each of the plurality of mobile wireless transmitters is associated with a receiver and a signaling device,
and the mobile device is designed so that, as soon as the mobile device receives the signal of a targeted storage location and/or a storage item via a corresponding signal to the receiver, the mobile device activates the associated signaling device, making a destination for deposit or retrieval perceivable on-site.

2. The storage organization system according to claim 1, wherein each of the plurality of mobile wireless transmitters intermittently transmits Bluetooth signals that the mobile device can receive and evaluate.

3. The storage organization system according to claim 2, wherein the Bluetooth signals sent by each of the plurality of mobile wireless transmitters have an average reception range of under 15 m, wherein the transmission power can be reduced to adapt to a structure of the respective storage area.

4. The storage organization system according to claim 1, wherein the mobile device can identify whether the mobile device can receive a signal from at least one of the plurality of mobile wireless transmitters that is on a correct path to the currently targeted storage location and then temporarily activates its signaling device so that the direction of travel is confirmed and/or whether the mobile device can receive a signal from at least one of the plurality of mobile wireless transmitters that is not on the correct path to the currently targeted storage location and then temporarily activates its signaling device to warn against incorrect travel direction.

5. The storage organization system according to claim 1, wherein at least one of the plurality of mobile wireless transmitters, one receiver, and one signaling device are grouped into a tag.

6. The storage organization system according to claim 5, wherein the tag bears a barcode or a QR code and the mobile device includes a scanner that can read the barcode or the QR code

7. The storage organization system according to claim 5, wherein the tag can be attached to any of the plurality of defined storage locations tool-free and non-removably using a magnet, a Velcro strip, a ball-locking bolt, or a snap-in base attached to the defined storage location.

8. The storage organization system according to claim 5, wherein the tag is battery-powered.

9. The storage organization system according to claim 8, wherein the tag activates the signaling device when the battery is nearing or has reached a depleted state.

10. The storage organization system according to claim 8, wherein the tag has electronic leakage detection or a time monitoring for the battery and activates the signaling device when there is a risk of battery leakage.

11. The storage organization system according to claim 1, wherein the signaling device is at least one LED.

12. The storage organization system according to claim 11, wherein the signaling device activates the at least one LED in a flashing manner to signal the targeted storage location or another condition.

13. The storage organization system according to claim 11, wherein the signaling device activates the at least one LED with different flashing patterns.

14. The storage organization system according to claim 5, wherein the tags are designed such that one tag can exchange data stored in at least one of the tags by approaching or contacting another tag.

15. The storage organization system according to claim 5, wherein a duration of the mobile device's stay in front of a specific tag can be stored in a retrievable manner.

16. The storage organization system according to claim 11, wherein the mobile device also has at least one LED and a control that allows the at least one LED to light up in the same manner as an LED of the targeted storage location.

17. The storage organization system according to claim 1, wherein the mobile device has a display that shows a map of the storage area at least when starting a new search run, in which a next storage location to be visited is noted.

18. The storage organization system according to claim 17, wherein the mobile device causes the at least one LED to light up only after displaying the map.

19. The storage organization system according to claim 18, wherein the mobile device triggers a provisioning process on-site when approaching, right after a first approach to the tag of the targeted storage location to be visited and/or the product to be retrieved.

20. The storage organization system according to claim 5, wherein the tag has a housing consisting of two half-shells.

21. The storage organization system according to claim 20, wherein one shell of the housing is transparent and allows a radiation of an LED mounted on a circuit board inside the housing to penetrate outward.

22. The storage organization system according to claim 21, wherein one shell of the housing is so opaque that an upper shell of the housing appears to glow entirely or predominantly due to the radiation of the LED inside the housing mounted on a circuit board.

23. The storage organization system according to claim 22, wherein the upper shell forms at least one light guide that directly reaches the LED and collects the radiation emitted by the LED and directs the radiation to the upper shell.
